(19) United States
(12) Patent Application Publication
(10) Pub. No.: US 2001/0035446 A1
(43) Pub. Date: Nov. 1, 2001

(54) Vehicle hitch-mounted bicycle carrier

(76) Inventors: Todd R. Walstrom, Ringle, WI (US); Joseph J. Peschmann, Plover, WI (US)

Correspondence Address: Edgar A. Zarins, MascoTech, Inc., 21001 Van Born Rd., Taylor, MI, 48180, US

(21) Appl. No.: 09/820,046

(22) Filed: Mar. 28, 2001

Related U.S. Application Data
(60) Provisional application No. 60/204,659, filed on May 17, 2000.

(51) Int. Cl. B60R 9/00; B60R 11/00

(52) U.S. Cl. 224/501; 224/519; 224/531; 224/534; 224/537; 224/901.4; 224/924

(57) ABSTRACT

A vehicle hitch-mounted carrier for transporting a plurality of bicycles proximate the rear of the vehicle. The carrier includes a plurality of bike racks adapted to retain a bicycle in a vertical position for independent access to the bicycles. The bike racks are mounted to the hitch structure of the vehicle and include a single or a pair of wheel frames adjustable attached to a vertical column. The bicycle wheels are nested within the frames to secure the bicycle in a vertical position.

### RELATED APPLICATIONS

This application claims priority from U.S. Provisional Application No. 60/204,659 filed on May 17, 2000.

### BACKGROUND OF THE INVENTION

I. Field of the Invention

This invention relates to bicycle carriers mountable to a hitch of a vehicle for convenient transport and, in particular, to a bike carrier which retains the bicycle in a vertical position for convenient loading and maximization of bicycles transported.

II. Description of the Prior Art

As sport utility vehicles have proliferated so has the desire for transporting recreational equipment. Vehicle hitches which were once used to tow trailers have become multipurpose devices for supporting carriers of all types. The vehicle hitch has been used to support cargo carriers, ski racks and bicycle racks. The goal of such carriers is to increase the storage capacity of the vehicle without unduly enlarging the vehicle profile. It is also desirable to provide easy access to the carried items which is an advantage of hitch-mounted carriers over rooftop carriers.

Bicycle carriers have been developed for vehicles of all shapes and sizes. Such carriers may include strap-on racks which include forks upon which the bikes are stacked. Rooftop carriers facilitate independent mounting of bicycles but do not provide convenient access. Typically, the front wheel of the bicycle needed to be removed so the fork could be clamped into the carrier. Even prior known hitch-mounted bicycle carriers simply stacked the bikes on a fork or similar structure requiring removal of all the bicycles to access the innermost bicycles.

### SUMMARY OF THE PRESENT INVENTION

The present invention overcomes the disadvantages of the prior known bicycle racks by providing a hitch mounted rack which facilitates independent retention of the bikes in a vertical position allowing access to any individual bicycle on the carrier.

The bicycle carrier of the present invention preferably includes a plurality of independent racks each capable of securing a bicycle for transport. The independent racks are each preferably selectively mountable to a vehicle hitch structure. In a preferred embodiment of the present invention, the hitch structure includes a crossbar having a plurality of receivers for receiving the independent bicycle racks. As a result, the bicycles are transported at the rear of the vehicle within the confines of the sides of the vehicle.

The independent bicycle racks include a vertical column having a substantially perpendicular boom adapted to be matingly received within the hitch structure. Adjustably mounted to the vertical column are a pair of wheel frames each adapted to removably receive one of the bicycle wheels. The wheel frames have an elongated configuration forming a slot for nestingly receiving the bicycle wheel. Each of the wheel frames are detachably secured to the vertical column so that they may be adjusted along the column to accommodate different size bicycles. One of the wheel frames is disposed above the other along the vertical column so as to retain the bicycle in a substantially vertical position. Wheel trays may also be mounted on the column for added stability in transporting the bicycle. Retaining means, preferably Velcro straps, may be utilized to secure the bicycle wheels to the vertical column.

Use of the independent bike racks allows independent transport and removal of as many bicycles as is desired. With the individual racks mounted to the hitch structure, a bicycle is lifted into position on the rack nesting the wheels within the wheel frames. Typically, the front wheel of the bicycle will be nested in the upper frame as the rear wheel is nested in the upper frame as the rear wheel is nested in the lower frame. Prior to positioning the bicycle, the frames will be adjusted according to the size of the bicycle. The Velcro straps can be utilized to secure the wheels to the vertical column.

Other objects, features and advantages of the invention will be apparent from the following detailed description taken in connection with the accompanying drawings.

### BRIEF DESCRIPTION OF THE DRAWING

The present invention will be more fully understood by reference to the following detailed description of a preferred embodiment of the present invention when read in conjunction with the accompanying drawing, in which like reference characters refer to like parts throughout the views and in which:

FIG. 1 is a perspective view of a vehicle with a hitch mounted bicycle carrier having a bicycle mounted thereon;

FIG. 2 is a side view of the bicycle carrier mounted to a vehicle hitch;

FIG. 3 is a front elevational view of the bicycle carrier;

FIG. 4 is a side view of the bicycle carrier; and

FIG. 5 is a side view of the bicycle carrier with a bicycle mounted thereon.

### DETAILED DESCRIPTION OF A PREFERRED EMBODIMENT OF THE PRESENT INVENTION

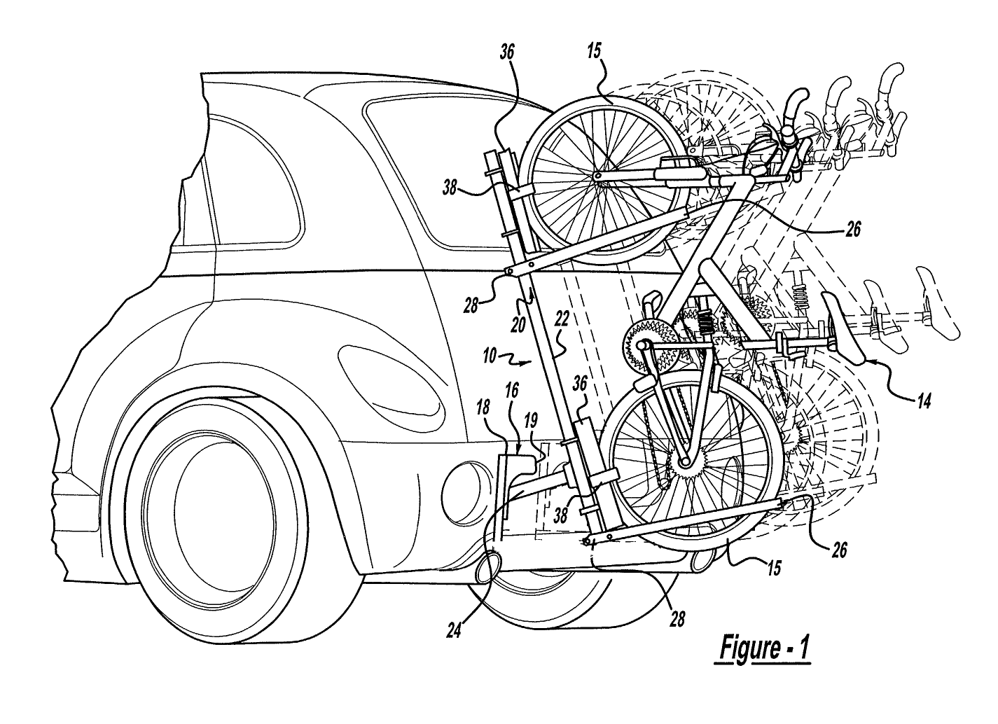

Referring first to FIG. 1, there is shown a bicycle carrier 10 mounted proximate the rear of a vehicle 12 for convenient transport of at least one bicycle 14. In a preferred embodiment, the bicycle carrier 10 is attached to the vehicle 12 through a hitch structure 16 substantially permanently mounted to the vehicle 12. The bicycles 14 are removably secured within the bicycle carrier 10 for transport with the vehicle 12 and subsequent removal and use at the destination.

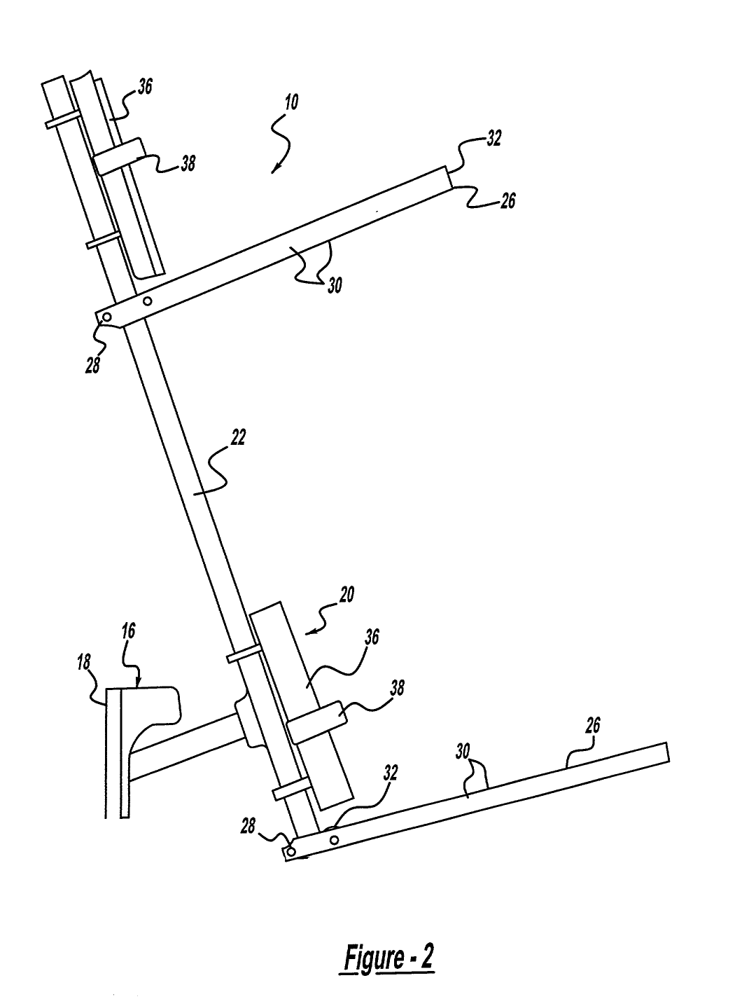

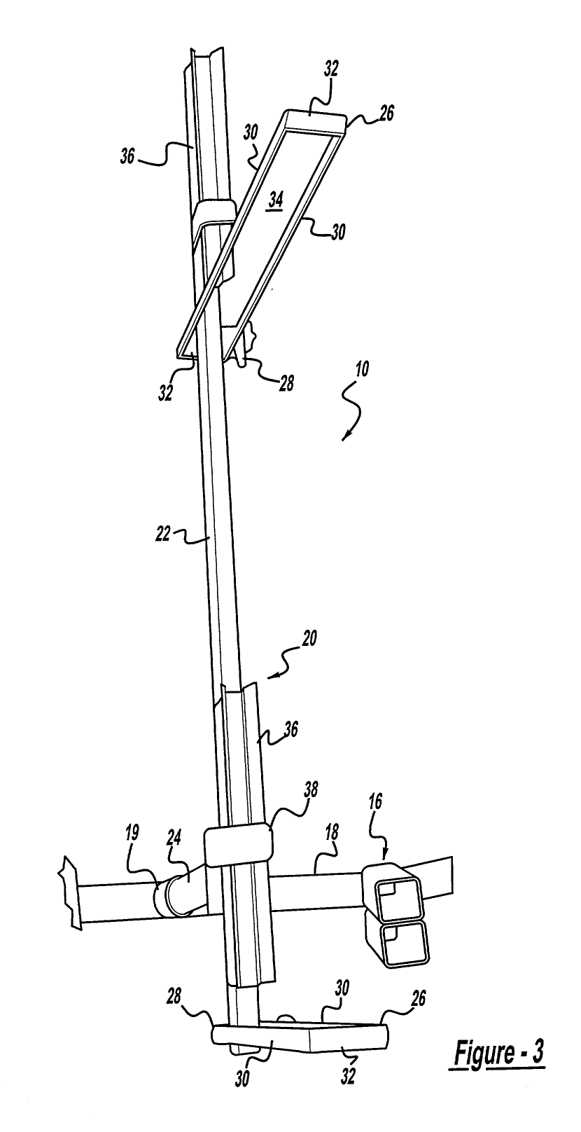

A preferred embodiment of the bicycle carrier 10 includes a plurality of bike racks 20 detachably mounted to the hitch structure 16. In one embodiment as best shown in FIGS. 1 through 3, the hitch structure 16 includes a crossbar 18 having a plurality of receivers 19 spaced along the crossbar 18 for receiving the bike racks 20. The receivers 19 are in the form of fixed tubes extending rearwardly from the crossbar 18 of the hitch structure 16 and are designed to support the bicycle carrier 10 cantilever fashion from the rear of the vehicle 12. Accordingly, a plurality of bike racks 20 corresponding to the number or receivers 19 may be mounted to the hitch structure 16.

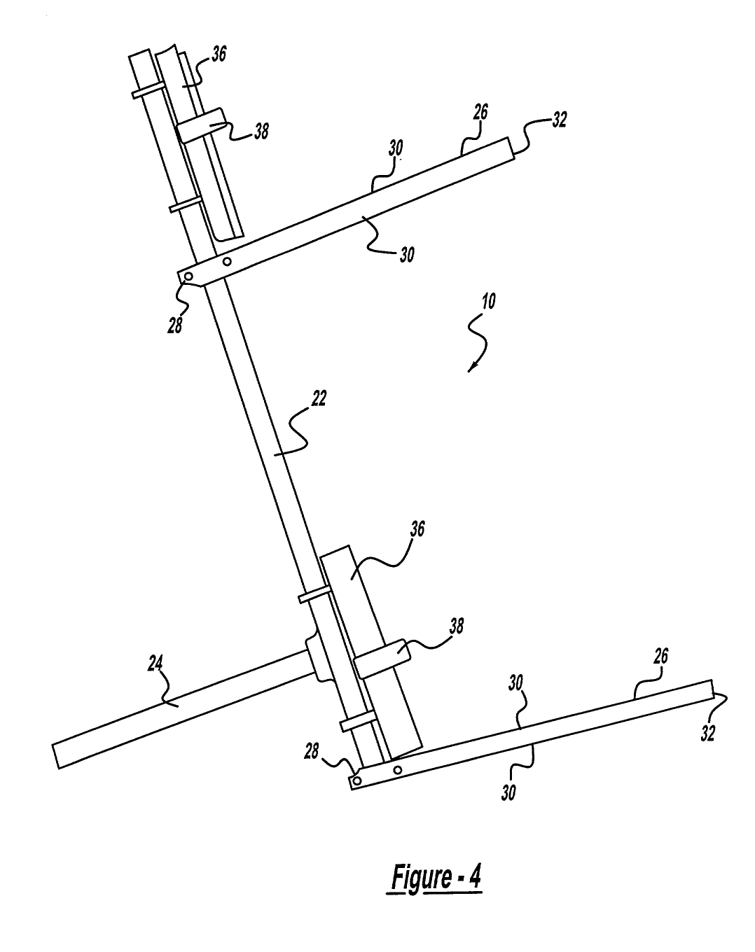

Referring now to FIGS. 1 through 5, the bike rack 20 includes a vertical column 22 having a perpendicular boom 24 extending therefrom. The boom 24 is configured to be matingly received within one of the receivers 19 to support the bike rack 20. Mounted to the vertical column 22 are a pair of wheel frames 26 adapted to nestably receive the wheels 15 of the bicycle 14. The wheel frames 26 are adjustably attached tot the vertical column 22 through a clamping assembly 28 which, when loosened, allows adjustment of the wheel frames 26 along the column 22 to accommodate different size bikes 14. The wheel frames 26 are constructed to receive the wheels 15 and preferably include a pair of parallel side bars 30 and end members 32 forming an elongated slot 34 for the wheel 15.

The bike racks 20 may include wheel trays 36 for supporting the wheels 15 of the bicycle 14. The trays 26 are preferably mounted to the vertical column 22 in parallel relation to the column 22. The trays 36 provide stabilizing support for the bicycle 14. Tie means, such as Velcro straps 38 associated with each of the trays 36, are used to attach the wheels 15 to the vertical column 22. Of course, more elaborate tie means could be used including a locking tie to prevent unauthorized removal of the bicycle 14 from the rack 20.

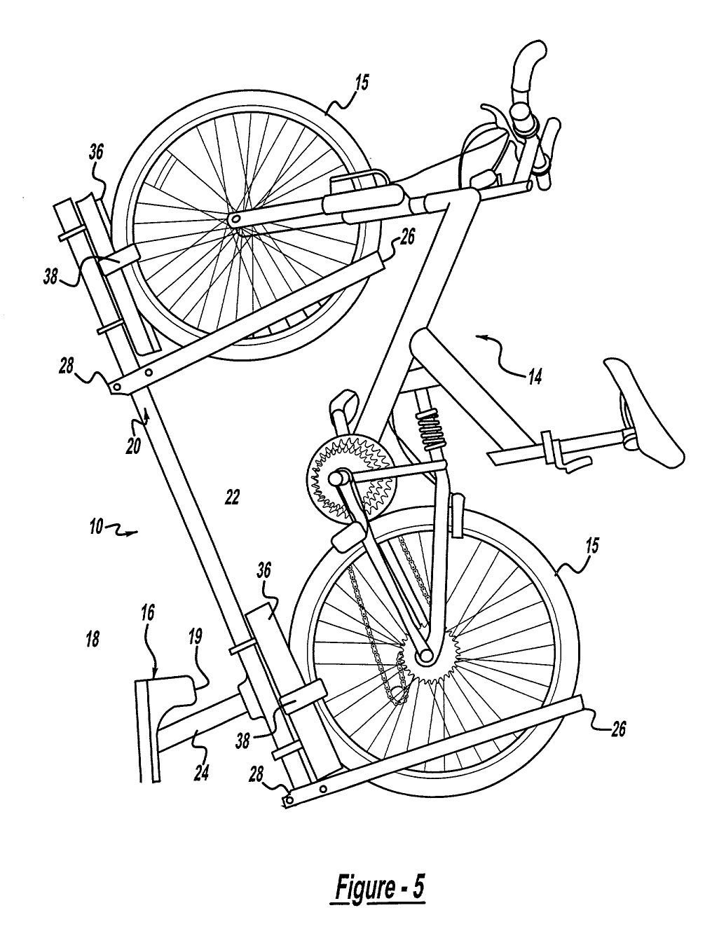

The bicycle carrier 10 of the present invention facilitates the transport of a plurality of bicycles 14 as well as the independent access to any one of the bikes 14. The number of bike racks 20 corresponding to the number of bicycles to be transported are mounted to the hitch structure 16 by inserting the boom 24 into the corresponding receiver 19 of the hitch 16. Alternatively, the plurality of bike racks 20 may be fixedly attached to the crossbar 16 such that the crossbar and all the racks are simultaneously removed from the vehicle 12. The bikes 14 are raised onto the bike rack 20 inserting the front wheel 15 into the upper wheel frame 26 and inserting the rear wheel 15 into the lower wheel frame 26 such that both wheels nest within the respective frame 26. The Velcro straps 38 are used to secure the wheels 15 as shown in FIGS. 1 and 5. Unlike prior known bicycle carriers 10 which required sequential removal of the outermost bicycle, the carrier 10 of the present invention provides access to any one of the bikes 14 transported on the carrier 10.

The foregoing detailed description has been given for clearness of understanding only and no unnecessary limitations should be understood therefrom as some modifications will be obvious to those skilled in the art without departing from the scope and spirit of the appended claims.

What is claimed is:

1. A bicycle carrier adapted to be mounted to a rear hitch of a vehicle, said carrier comprising:
at least one bike rack adapted to retain a bicycle having wheels, said at least one bike rack removably mounted to the vehicle hitch, said at least one bike rack supporting the bicycle in an upright end over end position.

2. The carrier as defined in claim 1 wherein a plurality of bike racks are detachably mounted to the vehicle hitch.

3. The carrier as defined in claim 1 wherein said at least one bike rack includes a vertical column with an upper and a lower wheel frame secured to said vertical column, said upper and lower wheel frames adapted to receive the wheels of the bicycle.

4. The carrier as defined in claim 3 wherein said upper and lower frames are adjustably attached to said vertical column to accommodate bicycles of different sizes.

5. The carrier as defined in claim 4 and further comprising tie means associated with said vertical column for securing the bicycle wheels to said vertical columns.

6. The carrier as defined in claim 4 wherein said at least one bike rack includes a boom extending from the vertical column, said boom received by the vehicle to support said at least one bike rack.

7. A bicycle carrier adapted to be mounted to a rear of a vehicle, said carrier comprising:
at least one bike rack adapted to retain a bicycle having wheels, said at least one bike rack removably mounted to the rear of the vehicle, said at least one bike rack including a substantially vertical column with an upper and a lower wheel frame attached to said vertical column, said upper and lower wheel frames adapted to receive the wheels of the bicycle to support the bicycle in an upright one end over the other end position.

8. The carrier as defined in claim 7 wherein a plurality of bike racks are detachably mounted to the vehicle.

9. The carrier as defined in claim 8 wherein said bike racks are mounted to a hitch of the vehicle.

10. The carrier as defined in claim 7 wherein said upper and lower wheel frames are adjustably attached to said column to accommodate bicycles of different sizes.

11. The carrier as defined in claim 10 and further comprising tie means associated with said vertical column for securing the bicycle wheels to said vertical column.

12. The carrier as defined in claim 9 wherein said at least one bike rack includes a boom extending from the vertical column, said boom received by the vehicle hitch to support said at least one bike rack.

13. A bicycle carrier adapted to be mounted to a rear hitch of a vehicle, said carrier comprising:
a plurality of bike racks adapted to retain a bicycle having wheels, said bike racks removably mounted in spaced apart relation transversely across the rear vehicle hitch, said bike racks including a substantially vertical column with an upper and a lower wheel frame attached to said vertical column and a boom extending from said vertical column, said boom removably received by the vehicle hitch and said wheel frames adapted to receive the wheels of the bicycle to support the bicycle in an upright position one end over the other end.

14. The carrier as defined in claim 13 wherein said upper and lower wheel frames are adjustably attached to said column to accommodate bicycles of different sizes.
